(19) United States
(12) Patent Application Publication
(10) Pub. No.: US 2021/0373908 A1
(43) Pub. Date: Dec. 2, 2021

(54) DATA TECHNIQUES FOR SYSTEM BOOT PROCEDURES

(71) Applicant: Micron Technology, Inc., Boise, ID (US)

(72) Inventors: Qing Liang, Boise, ID (US); Jonathan S. Parry, Boise, ID (US); Nadav Grosz, Broomfield, CO (US)

(21) Appl. No.: 16/888,212

(22) Filed: May 29, 2020

(51) Int. Cl. G06F 9/4401; G06F 12/10

(52) U.S. Cl. CPC G06F 9/4403; G06F 2212/657; G06F 12/10

(57) ABSTRACT

Methods, systems, and devices for data techniques for system boot procedures are described. A memory system may receive, from a host system, a set of commands as part of a boot procedure of the host system. The set of commands may request data stored in a first set of locations of a memory array of the memory system. The memory system may retrieve, as part of the boot procedure, the data from the first set of locations based on receiving the commands. The memory system may determine an order that the data is retrieved from each location of the first set of locations. The memory system may transfer the data from the first set of locations to a second set of locations based on the order that the data is retrieved from each location of the first set of locations.

### BACKGROUND

The following relates generally to one or more systems for memory and more specifically to data techniques for system boot procedures.

Memory devices are widely used to store information in various electronic devices such as computers, wireless communication devices, cameras, digital displays, and the like. Information is stored by programing memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read, or sense, the state of one or more memory cells within the memory device. To store information, a component may write, or program, one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), ferroelectric RAM (FeRAM), magnetic RAM (MRAM), resistive RAM (RRAM), flash memory, phase change memory (PCM), 3-dimensional cross-point memory (3D Xpoint), not-or (NOR), and not-and (NAND) memory devices, and others. Memory devices may be volatile or non-volatile. Volatile memory cells (e.g., DRAM cells) may lose their programmed states over time unless they are periodically refreshed by an external power source. Non-volatile memory cells (e.g., NAND memory cells) may maintain their programmed states for extended periods of time even in the absence of an external power source.

### BRIEF DESCRIPTION OF THE DRAWINGS

FIG. 1 illustrates an example of a system that supports data techniques for system boot procedures in accordance with examples as disclosed herein.

FIG. 2 illustrates an example of a data scheme that supports data techniques for system boot procedures in accordance with examples as disclosed herein.

FIG. 3 shows a block diagram of a memory system that supports data techniques for system boot procedures in accordance with examples as disclosed herein.

FIGS. 4 and 5 show flowcharts illustrating a method or methods that support data techniques for system boot procedures in accordance with examples as disclosed herein.

### DETAILED DESCRIPTION

Some systems (e.g., electronic devices, smart phones, etc.) may take a particular amount of time to boot-up. For example, a host system may request data from a memory system of the system during a boot-up procedure (e.g., upon providing power to the devices). In some cases, boot-up procedures may take a relatively long time to perform, for example, due to the host system requesting relatively large amounts of data during a boot-up procedure (e.g., it may take a relatively large time period to read the requested data). Such a relatively long time for a boot-up procedure may result in a memory system experiencing performance loss, increased signaling or processing overhead, or increased power consumption. Thus, it may be desirable to improve a user's experience by reducing the boot-up time of the overall system, which may result in increased efficiency of the memory system, among other benefits.

Systems, devices, and techniques are described for a memory system to organize at least some data (e.g., information) for system boot procedures of a host system. For example, a host system may send one or more commands to the memory system requesting data as part of a system boot procedure. The memory system may determine an order of the commands (e.g., a sequential order of locations from which the memory system reads the data). The memory system may re-organize the requested data based on the order. For example, the memory system may transfer the data from a random pattern to a sequential layout of physical addresses in accordance with the order of the one or more commands as described herein. Such techniques may result in reduced boot-up times (e.g., due to more efficient retrieval of the re-organized data for the boot procedure), improved read speeds, reduce power consumption, decreased processing complexity, and improved processing times, among other benefits.

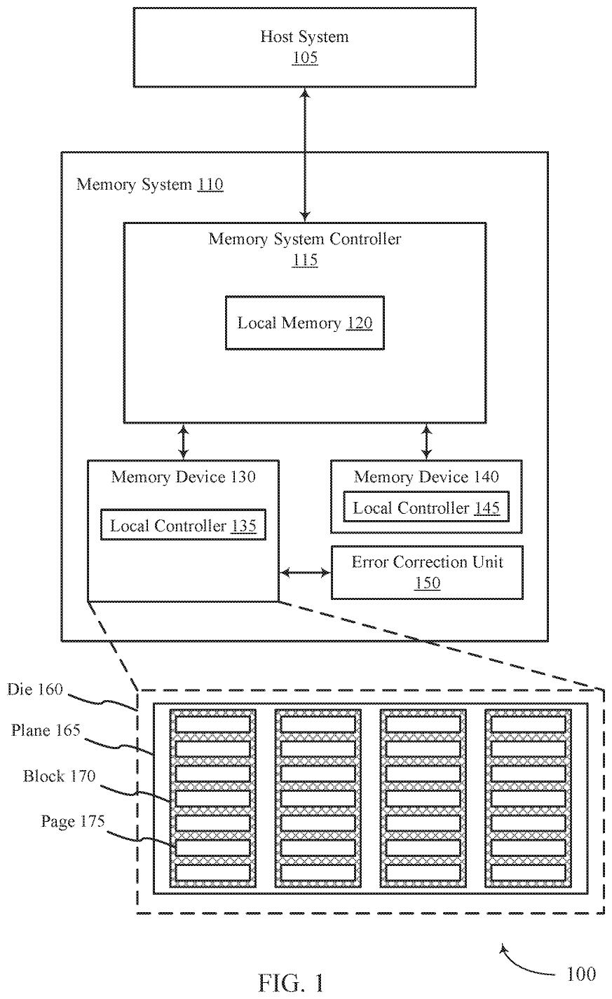

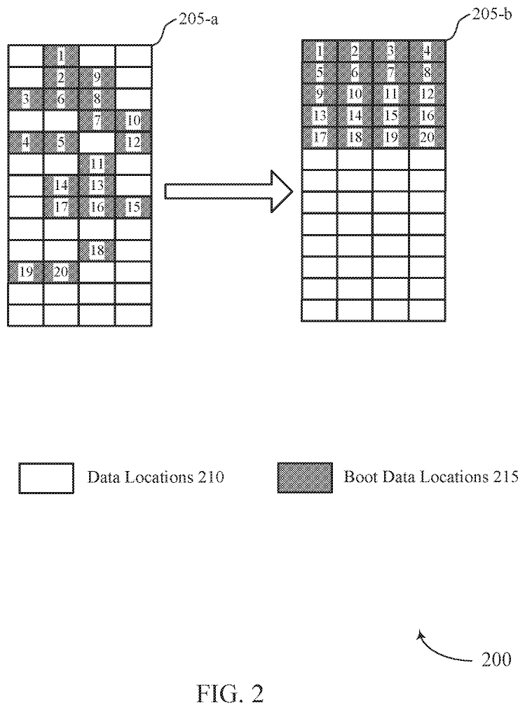

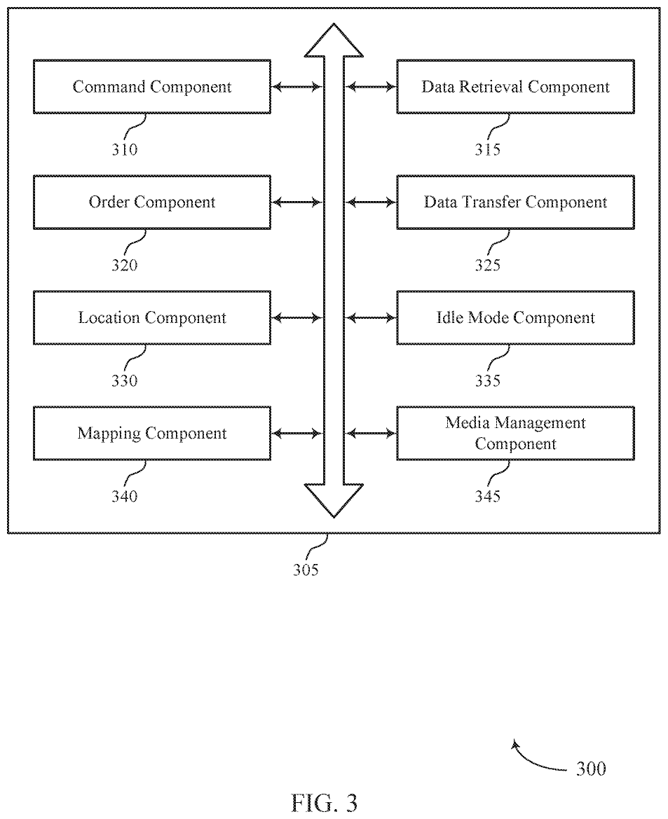

Features of the disclosure are initially described in the context of a system as described with reference to FIG. 1. Features of the disclosure are described in the context of a data scheme as described with reference to FIG. 2. These and other features of the disclosure are further illustrated by and described with reference to an apparatus diagram and flowcharts that relate to data techniques for system boot procedures as described with reference to FIGS. 3-5.

FIG. 1 illustrates an example of a system 100 that supports data techniques for system boot procedures in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. The host system 105 may include one or more devices, and in some cases may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., PCIe controller, serial advanced technology attachment (SATA) controller). The host system 105 may use the memory system 110, for example, to write data to the memory system 110 and read data from the memory system 110. Though one memory system 110 is shown in FIG. 1, it is to be understood that the host system 105 may be coupled with any quantity of memory systems 110.

The host system 105 may be coupled with the memory system 110 via at least one physical host interface. The host system 105 and the memory system 110 may in some cases be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a peripheral component interconnect express (PCIe) interface, USB interface, Fiber Channel, Small Computer System Interface (SCSI), Serial Attached SCSI (SAS), a double data rate (DDR) memory bus, a DIMM interface (e.g., DIMM socket interface that supports DDR), Open NAND Flash Interface (ONFI), DDR, Low Power Double Data Rate (LPDDR). In some cases, the host system 105 may be coupled with the memory system 110 via a respective physical host interface for each memory device 130 or memory device 140 included in the memory system 110, or via a respective physical host interface for each type of memory device 130 or memory device 140 included in the memory system 110.

Memory system 110 may include a memory system controller 115, a memory device 130, and a memory device 140. A memory device 130 may include one or more memory arrays of a first type of memory cells (e.g., a type of non-volatile memory cells), and a memory device 140 may include one or more memory arrays of a second type of memory cells (e.g., a type of volatile memory cells). Though one memory device 130 and one memory device 140 are shown in the example of FIG. 1, it is to be understood that memory system 110 may include any quantity of memory devices 130 and memory devices 140, and that, in some cases, memory system 110 may lack either a memory device 130 or a memory device 140.

The memory system controller 115 may be coupled with and communicate with the host system 105 (e.g., via the physical host interface). The memory system controller 115 may also be coupled with and communicate with memory devices 130 or memory devices 140 to perform operations such as reading data, writing data, erasing data, or refreshing data at a memory device 130 or a memory device 140, and other such operations, which may generically be referred to as access operations. In some cases, the memory system controller 115 may receive commands from the host system 105 and communicate with one or more memory devices 130 or memory devices 140 to execute such commands (e.g., at memory arrays within the one or more memory devices 130 or memory devices 140). For example, the memory system controller 115 may receive commands or operations from the host system 105 and may convert the commands or operations into instructions or appropriate commands to achieve the desired access of the memory devices 130 or memory devices 140. And in some cases, the memory system controller 115 may exchange data with the host system 105 and with one or more memory devices 130 or memory devices 140 (e.g., in response to or otherwise in association with commands from the host system 105). For example, the memory system controller 115 may convert responses (e.g., data packets or other signals) associated with the memory devices 130 or memory devices 140 into corresponding signals for the host system 105.

The memory system controller 115 may be configured for other operations associated with the memory devices 130 or memory devices 140. For example, the memory system controller 115 may execute or manage operations such as wear-leveling operations, garbage collection operations, error checking operations or error correcting code (ECC) operations such as error-detecting operations or error-correcting operations, encryption operations, caching operations, media management operations, and address translations between logical addresses (e.g., logical block addresses (LBAs)) associated with commands from the host system 105 and physical addresses (e.g., physical block addresses) associated with memory cells within the memory devices 130 or memory devices 140.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally or alternatively include static random access memory (SRAM) or other memory that may be used by the memory system controller 115 for internal storage or calculations, for example, related to the functions ascribed herein to the memory system controller 115. Additionally or alternatively, the local memory 120 may serve as a cache for the memory system controller 115. For example, data may be stored to the local memory 120 when read from or written to a memory device 130 or memory device 140, and may be available within the local memory 120 for subsequent retrieval for or manipulation (e.g., updating) by the host system 105 (e.g., with reduced latency relative to a memory device 130 or memory device 140) in accordance with a cache policy.

Although the example of memory system 110 in FIG. 1 has been illustrated as including the memory system controller 115, in some cases, a memory system 110 may not include a memory system controller 115. For example, the memory system 110 may additionally or alternatively rely upon an external controller (e.g., implemented by the host system 105) or one or more local controllers 135 or local controllers 145, which may be internal to memory devices 130 or memory devices 140, respectively, to perform the functions ascribed herein to the memory system controller 115. In general, one or more functions ascribed herein to the memory system controller 115 may in some cases instead be performed by the host system 105, a local controller 135, or a local controller 145, or any combination thereof. In some cases, the memory system 110 may include non-transitory computer-readable medium (CRM) (e.g., local memory 120, memory device 130, and/or memory device 140) storing instructions (e.g., firmware) for performing the methods described herein (e.g., methods 400 and 500). For example, the instructions, when executed by controller 115 (or more specifically processor of a controller 115), cause the controller to perform the methods described herein.

A memory device 140 may include one or more arrays of volatile memory cells. For example, a memory device 140 may include random access memory (RAM) memory cells, such as dynamic RAM (DRAM) memory cells and synchronous DRAM (SDRAM) memory cells. In some examples, a memory device 140 may support random access operations (e.g., by the host system 105) with reduced latency relative to a memory device 130, or may offer one or more other performance differences relative to a memory device 130.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric RAM (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), and electrically erasable programmable ROM (EEPROM).

In some examples, a memory device 130 or a memory device 140 may include (e.g., on a same die or within a same package) a local controller 135 or a local controller 145, respectively, which may execute operations on one or more memory cells of the memory device 130 or the memory device 140. A local controller 135 or a local controller 145 may operate in conjunction with a memory system controller 115 or may perform one or more functions ascribed herein to the memory system controller 115. In some cases, a memory device 130 or a memory device 140 that includes a local controller 135 or a local controller 145 may be referred to as a managed memory device and may include a memory array and related circuitry combined with a local (e.g., on-die or in-package) controller (e.g., local controller 135 or local controller 145). An example of a managed memory device is a managed NAND (MNAND) device.

In some cases, a memory device 130 may be or include a NAND device (e.g., NAND flash device). The memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may take place within different planes 165. For example, concurrent operations may be performed on memory cells within different blocks 170 so long as the different blocks 170 are in different planes 165. In some cases, performing concurrent operations in different planes 165 may be subject to one or more restrictions, such as identical operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may not be updated without the entire block 170 that includes the page 175 being erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete, and update an L2P mapping table to associate the logical address (e.g., LBA) for the data with the new, valid block 170 rather than the old, invalid block 170. In some cases, such copying and remapping may be preferable to erasing and rewriting the entire old block 170, due to latency or wearout considerations, for example. In some cases, one or more copies of an L2P mapping table may be stored within the memory cells of the memory device 130 (e.g., within or more blocks 170 or planes 165) for use (e.g., reference and updating) by the local controller 135 or memory system controller 115.

In some cases, L2P tables may be maintained and data may be marked as valid or invalid at the page level of granularity, and a page 175 may contain valid data, invalid data, or no data. Invalid data may be data that is outdated due to a more recent or updated version of the data being stored in a different page 175 of the memory device 130. Invalid data have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has not been written to or that has been erased.

In some cases, a memory system controller 115, a local controller 135, or a local controller 145 may perform operations (e.g., as part of one or more media management algorithms) for a memory device 130 or a memory device 140, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for some or all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the number of blocks 170 that have been erased may be increased such that more blocks 170 are available to store subsequent data (e.g., data subsequently received from the host system 105).

In some examples, the memory system 110 may include an error control unit (ECU) 150. For example, the ECU 150 may be in electronic communication with a memory device 130, a memory device 140, one or more controllers (e.g., the memory system controller 115 and/or a local controller 135), or any combination thereof. The ECU 150 may perform operations such as error detection operations, error correction operations, error correcting code operations, or a combination thereof. In some cases, a portion of the NAND of the memory device 130 may store a replay script (e.g., a boot sequence). The replay script may include the commands and addresses of the boot procedure to track the location of requested boot data during the boot procedure

In some examples, the memory system 110 may implement one or more operations for organizing at least some data for system boot procedures of the host system 105. For example, the host system 105 may send one or more commands to the memory system 110 requesting data as part of a system boot procedure. The memory system 110 may determine an order of the commands (e.g., a sequential order of locations that the memory system 110 reads the data). The memory system 110 may re-organize the requested data based on the order. For example, the memory system 110 may transfer the data from a random pattern to a sequential layout in accordance with the order of the one or more commands as described herein. Such techniques may result in reduced boot-up times (e.g., due to more efficient retrieval of the re-organized data for the boot procedure), improved read speeds, reduce power consumption, decreased processing complexity, and improved processing times, among other benefits.

FIG. 2 illustrates an example of a data scheme 200 that supports data techniques for system boot procedures in accordance with examples as disclosed herein. The data scheme 200 may be implemented by processing logic that may include hardware (e.g., processing device, circuitry, dedicated logic, programmable logic, microcode, hardware of a device, integrated circuit, etc.), software (e.g., instructions run or executed on a processing device), or a combination thereof. In some examples, the data scheme 200 may be implemented by a memory system or a system of memory systems as described with reference to FIGS. 1 and 3. In some examples, a memory system may execute a set of codes to control the functional elements of the memory system to perform the operations described below. Additionally or alternatively, the memory system may perform aspects of the operations described below using special-purpose hardware.

In some examples, a memory system may implement the data layouts 205 for performing system boot procedures (e.g., boot-up procedures). The data layout 205-a may show an illustrative example of a random data pattern for boot data locations 215 and the data layout 205-b may show an illustrative example of a sequential data pattern for the boot data locations 215. For example, the data layouts 205 may include data locations 210, which may be examples of physical addresses of a memory array of the memory system that store data (e.g., data stored on pages 175, blocks 170, etc.). Additionally or alternatively, the data layouts 205 may include boot data locations 215, which may be examples of physical addresses of the memory array that store data requested by a host system as part of a system boot procedure (e.g., a boot-up procedure).

The memory system may identify an occurrence of such a boot procedure. For example, a memory system may identify one or more commands from a host system indicating a boot procedure (e.g., a command for a boot procedure, one or more read commands associated with the boot procedure, among other examples of commands indicating a boot procedure). The boot procedure may occur when the host system powers up (e.g., turns on) or when an application associated with the host system is activated. For example, a boot procedure may occur when an operating system implemented by the host system is activated.

As part of the boot procedure, the memory system may access the boot data locations 215 (e.g., physical addresses of a memory device). For example, the host system may send one or more read commands requesting data from the memory system stored at the boot data locations 215 (e.g., data used by the host system to boot-up). The memory system may perform read operations for the boot data locations 215 based on the set of read commands and provide the requested data to the host system. In some examples, the memory system may access the boot data locations 215 in a sequential order based on a sequential order of the received set of read commands. For example, the boot data locations 215 of the data layout 205-a may include index numbers illustrating an order that the boot data locations 215 are accessed as part of the system boot procedure (e.g., the memory system may access the boot data location 215 labeled “1,” based on a first read command of the set of read commands, the memory system may access the boot data location 215 labeled “2” after accessing the boot data location 215 labeled “1” based on a second read command of the set of read commands, and so on). The memory system may signal the read data from the boot data locations 215 in response to the one or more commands.

In some examples, the memory system may perform the boot procedure using the data layout 205-a. The boot data locations 215 of the data layout 205-a (e.g., a first set of locations) may be located in a memory array of the memory system in accordance with a “random” pattern, meaning there is no correlation between an order that the data is retrieved and the physical addresses where the data is stored. As an illustrative example, the data requested for the boot procedure (e.g., the boot data locations 215 storing the data used for the boot procedure) may be scattered throughout the data layout 205-a (e.g., the physical and/or logical addresses of the boot data may be scattered). In some examples, the memory system may perform a garbage collection procedure, which may result in the random pattern illustrated by the data layout 205-a (e.g., pages may be moved across blocks during the garbage collection procedure, which may scatter the boot data locations 215). Additionally or alternatively, the pattern of the data layout 205-a may be a result of read disturbances (e.g., a read disturb of a page may result in data being moved to a new block) and/or a host system updating the boot image (e.g., updating the boot data may result in scattering one or more of the boot data locations 215). However, in some examples, such a data layout 205-a may be relatively inefficient. For example, performing a boot procedure using the random pattern of the boot data locations 215 may be relatively inefficient, which may result in a relatively long time to perform the boot procedure.

The memory system may be enabled to re-organize the boot data locations 215 to a sequential pattern (e.g., a sequential layout) of physical address, for example, illustrated by the data layout 205-b. For example, the memory system may determine an order of commands received for a boot procedure (e.g., a sequential order of read commands for the boot data locations 215). As an illustrative example, the memory system may determine the order that the boot data locations 215 are accessed during a first boot procedure using the data layout 205-a (e.g., the memory system may track or record that the boot data location 215 labeled “1” is accessed first, the boot data location 215 labeled “2” is accessed second, and so on, until an order that data is retrieved from each of the boot data locations 215 is determined). That is, the memory system may record the sequential access pattern of the first boot procedure to determine the order. In some examples, the order is stored as a list of physical block addresses (PBAs). In some examples, the list is stored in SRAM of the memory system until defragmentation occurs (e.g., until the data is transferred using the list during an idle period of the memory system).

The memory system may transfer the boot data locations 215 based on the determined order. For example, the memory system may transfer the boot data locations 215 illustrated by the data layout 205-a (e.g., a first set of physical addresses for the boot data) to the boot data locations 215 illustrated by the data layout 205-b (e.g., a second set of physical addresses for the boot data). The memory system may transfer the data such that the boot data locations 215 are arranged in a different pattern (e.g., the boot data locations 215 may be transferred to physical addresses that are packed closer together). The memory system may transfer the boot data in accordance with a determined order. For example, the memory system may organize the boot data locations 215 in the data layout 205-b such that the boot data locations 215 may be accessed in a sequential pattern (e.g., the boot data locations may be arranged physically in the order that the boot data locations 215 are read in a boot procedure), as shown for illustrative clarity in the data layout 205-b, although it is to be understood that other data layouts 205 may be used (e.g., the index values of the data layout 205-b may increase from the right to the left, from the top of the data layout 205-b to the bottom of the data layout 205-b, among other examples).

In some examples, the memory system may transfer the data to the boot data locations 215 of the data layout 205-b during an idle period of the memory system (e.g., during a time period that the memory system is operating in an idle mode). For example, the memory system may determine the access order of the boot data locations 215 of the data layout 205-a during a first boot procedure (e.g., during a first time period). Subsequent to the boot procedure, the memory system may enter an idle mode (e.g., during a time period where the memory system may be relatively inactive). During the idle mode, the memory system may transfer the boot data from the boot data locations 215 of the data layout 205-a (e.g., a first set of physical addresses) to boot data locations 215 of the data layout 205-b (e.g., a second set of physical addresses). The memory system may perform a second boot procedure using the data layout 205-b. For example, the memory system may retrieve boot data requested by the host system from the boot data locations 215 in a sequential pattern (e.g., sequential in time and physical location, as illustrated by the example of the data layout 205-b).

In some examples, the memory system may update a mapping table based on transferring the data. The mapping table may include a correspondence between one or more logical addresses (e.g., LBAs) of the memory array and one or more physical addresses (e.g., data locations 210) of the memory array. In some cases, the mapping table may be an example of a logical-to-physical (L2P) mapping table. The memory system may update the mapping table based on transferring the data. For example, the memory system may update a first mapping (e.g., one or more entries of the L2P table indicating a correspondence between LBAs and physical block addresses (PBAs) of the boot data) associated with the data layout 205-a to a second mapping associated with the data layout 205-b upon transferring the data. In some examples, the memory system may adjust a granularity of one or more entries of the mapping table based on the transferring. A granularity may indicate a quantity of physical addresses that correspond to a logical address. For example, the first mapping of the boot data may use a first granularity (e.g., for a 4 kilobyte (kB) granularity, 1 megabyte (MB) of SRAM may map to 1 gigabyte (GB) of physical NAND locations, among other examples of granularities) and the second mapping of the boot data may be adjusted to use a second granularity (e.g., a 64 kB granularity, a 128 kB granularity, etc.). The second granularity may be relatively larger than the first granularity, for example, because the boot data may be aggregated in a relatively large data chunk due to transferring the data as described herein. Such adjustments may enable more efficient memory operations. For example, the memory system may use less SRAM to map the boot data using the larger granularity, which may enable the device to use the free SRAM space for read buffering, among other advantages.

In some examples, the memory system may transfer the data and/or determine the boot data locations 215 of the data layout 205-b (e.g., a second set of physical addresses) based on one or more media management operations. For example, the memory system may identify a relatively low-wear memory block (e.g., a portion of the memory array that has been accessed relatively infrequently) based on a media management operation. The memory system may move the boot data to the identified memory block. In some examples, the data stored at the boot data locations 215 may be identified by a flag for the media management operations, which may enable media management operations to treat the boot data locations 215 different than the data locations 210 (e.g., one or more rules may be different for the flagged boot data for one or more media management operations, such as refresh algorithms, read disturb operations, etc.).

In some examples, the techniques described herein may result in one or more advantages. For example, re-organizing the boot data from a random access pattern (e.g., illustrated by the example of the data layout 205-a) to a sequential pattern (e.g., illustrated by the example of the data layout 205-b) may enable the memory system to realize reduced boot-up times. Additionally or alternatively, implementing the data layout 205-b may result in a relatively lower latency for a host system to receive the boot data, more efficient NAND sensing due to read data being packed on a same access line (e.g., a word line in the data layout 205-b may include a higher density of target boot data locations 215 compared to the data layout 205-a), efficiency gains in the memory system (e.g., if pages storing the boot data are consecutive and/or in the same block there may be efficiency gains for multi-plane read operations, single pass-read operations, cache read operations, etc.), among other benefits.

FIG. 3 shows a block diagram 300 of a memory system 305 that supports data techniques for system boot procedures in accordance with examples as disclosed herein. The memory system 305 may be an example of aspects of a memory system as described with reference to FIGS. 1 and 2. The memory system 305 may include a command component 310, a data retrieval component 315, an order component 320, a data transfer component 325, a location component 330, an idle mode component 335, a mapping component 340, and a media management component 345. Each of these modules may communicate, directly or indirectly, with one another (e.g., via one or more buses).

The command component 310 may receive, from a host system, a set of commands as part of a boot procedure of the host system, the set of commands requesting data stored in a first set of locations of a memory array. In some examples, the command component 310 may receive, from the host system, a second set of commands of a second boot procedure, the second set of commands requesting the data.

The data retrieval component 315 may retrieve, as part of the boot procedure, the data from the first set of locations of the memory array based on receiving the set of commands. In some examples, the data retrieval component 315 may retrieve, as part of the second boot procedure, the data from the second set of locations of the memory array based on receiving the second set of commands and transferring the data from the first set of locations to the second set of locations. In some examples, the data retrieval component 315 may access a word line including a sequential set of physical addresses storing the data, the second set of locations including the sequential set of physical addresses.

The order component 320 may determine an order that the data is retrieved from each location of the first set of locations as part of the boot procedure.

The data transfer component 325 may transfer the data from the first set of locations to a second set of locations based on the order that the data is retrieved from each location of the first set of locations. In some examples, the data transfer component 325 may transfer the data from a first set of physical addresses to a second set of physical addresses, where the first set of physical addresses correspond to a first pattern and the second set of physical addresses correspond to a second pattern different than the first pattern. In some cases, the first pattern includes a random pattern and the second pattern includes a sequential pattern.

The location component 330 may determine the second set of locations in the memory array for storing the data based on the order that the data is retrieved, the second set of locations including a sequential set of physical addresses in the memory array, where transferring the data is based on determining the second set of locations. In some examples, the location component 330 may determine the second set of locations in the memory array for storing the data based on the one or more media management operations.

The idle mode component 335 may operate in an idle mode subsequent to determining the order that the data is retrieved from the each location of the first set of locations, where transferring the data from the first set of locations to the second set of locations is based on operating in the idle mode.

The mapping component 340 may update a mapping table based on transferring the data from the first set of locations to the second set of locations, the mapping table including a correspondence between one or more logical addresses and one or more physical addresses of the memory device. In some examples, the mapping component 340 may update a first mapping associated with the data to a second mapping associated with the data, the first mapping indicating a correspondence between one or more logical addresses of the data and a first set of physical addresses of the data, the second mapping indicating a correspondence between the one or more logical addresses of the data and a second set of physical addresses of the data. In some examples, the mapping component 340 may adjust a granularity of an entry of the mapping table, the granularity indicating a quantity of physical addresses of the data that correspond to a logical address of the data.

The media management component 345 may perform one or more media management operations for the memory array. In some examples, the media management component 345 may identify that the data is associated with the boot procedure, where determining the second set of locations is based on the data being associated with the boot procedure.

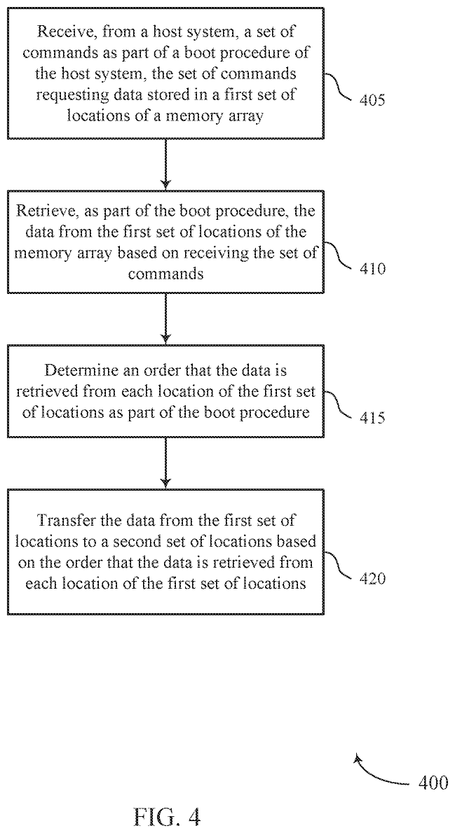

FIG. 4 shows a flowchart illustrating a method or methods 400 that supports data techniques for system boot procedures in accordance with examples as disclosed herein. The operations of method 400 may be implemented by a memory system or its components as described herein. For example, the operations of method 400 may be performed by a memory system as described with reference to FIG. 3. In some examples, a memory system may execute a set of instructions to control the functional elements of the memory system to perform the described functions. Additionally or alternatively, a memory system may perform aspects of the described functions using special-purpose hardware. In some examples, method 400 may be implemented as instructions stored in memory (e.g., firmware stored in local memory). For example, the instructions, when executed by a controller, may cause the controller to perform the operations of method 400.

At 405, the memory system may receive, from a host system, a set of commands as part of a boot procedure of the host system, the set of commands requesting data stored in a first set of locations of a memory array. The operations of 405 may be performed according to the methods described herein. In some examples, aspects of the operations of 405 may be performed by a command component as described with reference to FIG. 3.

At 410, the memory system may retrieve, as part of the boot procedure, the data from the first set of locations of the memory array based on receiving the set of commands. The operations of 410 may be performed according to the methods described herein. In some examples, aspects of the operations of 410 may be performed by a data retrieval component as described with reference to FIG. 3.

At 415, the memory system may determine an order that the data is retrieved from each location of the first set of locations as part of the boot procedure. The operations of 415 may be performed according to the methods described herein. In some examples, aspects of the operations of 415 may be performed by an order component as described with reference to FIG. 3.

At 420, the memory system may transfer the data from the first set of locations to a second set of locations based on the order that the data is retrieved from each location of the first set of locations. The operations of 420 may be performed according to the methods described herein. In some examples, aspects of the operations of 420 may be performed by a data transfer component as described with reference to FIG. 3.

In some examples, an apparatus as described herein may perform a method or methods, such as the method 400. The apparatus may include features, means, or instructions (e.g., a non-transitory computer-readable medium storing instructions executable by a processor) for receiving, from a host system, a set of commands as part of a boot procedure of the host system, the set of commands requesting data stored in a first set of locations of a memory array, retrieving, as part of the boot procedure, the data from the first set of locations of the memory array based on receiving the set of commands, determining an order that the data is retrieved from each location of the first set of locations as part of the boot procedure, and transferring the data from the first set of locations to a second set of locations based on the order that the data is retrieved from each location of the first set of locations.

Some examples of the method 400 and the apparatus described herein may further include operations, features, means, or instructions for determining the second set of locations in the memory array for storing the data based on the order that the data may be retrieved, the second set of locations including a sequential set of physical addresses in the memory array, where transferring the data may be based on determining the second set of locations.

In some examples of the method 400 and the apparatus described herein, transferring the data from the first set of locations to the second set of locations may include operations, features, means, or instructions for transferring the data from a first set of physical addresses to a second set of physical addresses, where the first set of physical addresses correspond to a first pattern and the second set of physical addresses correspond to a second pattern different than the first pattern.

In some examples of the method 400 and the apparatus described herein, the first pattern includes a random pattern and the second pattern includes a sequential pattern.

Some examples of the method 400 and the apparatus described herein may further include operations, features, means, or instructions for operating in an idle mode subsequent to determining the order that the data may be retrieved from the each location of the first set of locations, where transferring the data from the first set of locations to the second set of locations may be based on operating in the idle mode.

Some examples of the method 400 and the apparatus described herein may further include operations, features, means, or instructions for receiving, from the host system, a second set of commands of a second boot procedure, the second set of commands requesting the data, and retrieving, as part of the second boot procedure, the data from the second set of locations of the memory array based on receiving the second set of commands and transferring the data from the first set of locations to the second set of locations.

In some examples of the method 400 and the apparatus described herein, retrieving the data from the second set of locations may include operations, features, means, or instructions for accessing a word line including a sequential set of physical addresses storing the data, the second set of locations including the sequential set of physical addresses.

Some examples of the method 400 and the apparatus described herein may further include operations, features, means, or instructions for updating a mapping table based on transferring the data from the first set of locations to the second set of locations, the mapping table including a correspondence between one or more logical addresses and one or more physical addresses of the memory device.

In some examples of the method 400 and the apparatus described herein, updating the mapping table may include operations, features, means, or instructions for updating a first mapping associated with the data to a second mapping associated with the data, the first mapping indicating a correspondence between one or more logical addresses of the data and a first set of physical addresses of the data, the second mapping indicating a correspondence between the one or more logical addresses of the data and a second set of physical addresses of the data.

In some examples of the method 400 and the apparatus described herein, updating the mapping table may include operations, features, means, or instructions for adjusting a granularity of an entry of the mapping table, the granularity indicating a quantity of physical addresses of the data that correspond to a logical address of the data.

Some examples of the method 400 and the apparatus described herein may further include operations, features, means, or instructions for performing one or more media management operations for the memory array, and determining the second set of locations in the memory array for storing the data based on the one or more media management operations.

In some examples of the method 400 and the apparatus described herein, performing the one or more media management operations may include operations, features, means, or instructions for identifying that the data may be associated with the boot procedure, where determining the second set of locations may be based on the data being associated with the boot procedure.

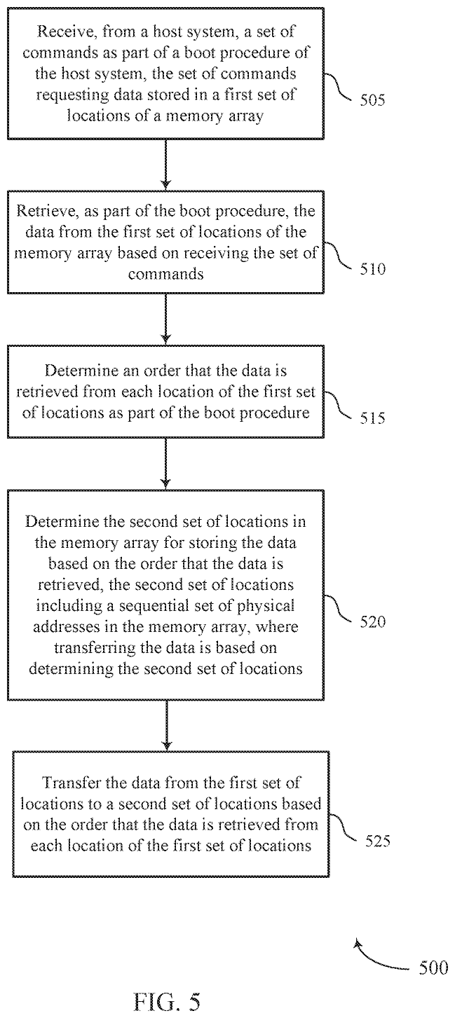

FIG. 5 shows a flowchart illustrating a method or methods 500 that supports data techniques for system boot procedures in accordance with examples as disclosed herein. The operations of method 500 may be implemented by a memory system or its components as described herein. For example, the operations of method 500 may be performed by a memory system as described with reference to FIG. 3. In some examples, a memory system may execute a set of instructions to control the functional elements of the memory system to perform the described functions. Additionally or alternatively, a memory system may perform aspects of the described functions using special-purpose hardware. In some examples, method 500 may be implemented as instructions stored in memory (e.g., firmware stored in local memory). For example, the instructions, when executed by a controller, may cause the controller to perform the operations of method 500.

At 505, the memory system may receive, from a host system, a set of commands as part of a boot procedure of the host system, the set of commands requesting data stored in a first set of locations of a memory array. The operations of 505 may be performed according to the methods described herein. In some examples, aspects of the operations of 505 may be performed by a command component as described with reference to FIG. 3.

At 510, the memory system may retrieve, as part of the boot procedure, the data from the first set of locations of the memory array based on receiving the set of commands. The operations of 510 may be performed according to the methods described herein. In some examples, aspects of the operations of 510 may be performed by a data retrieval component as described with reference to FIG. 3.

At 515, the memory system may determine an order that the data is retrieved from each location of the first set of locations as part of the boot procedure. The operations of 515 may be performed according to the methods described herein. In some examples, aspects of the operations of 515 may be performed by an order component as described with reference to FIG. 3.

At 520, the memory system may determine the second set of locations in the memory array for storing the data based on the order that the data is retrieved, the second set of locations including a sequential set of physical addresses in the memory array, where transferring the data is based on determining the second set of locations. The operations of 520 may be performed according to the methods described herein. In some examples, aspects of the operations of 520 may be performed by a location component as described with reference to FIG. 3.

At 525, the memory system may transfer the data from the first set of locations to a second set of locations based on the order that the data is retrieved from each location of the first set of locations. The operations of 525 may be performed according to the methods described herein. In some examples, aspects of the operations of 525 may be performed by a data transfer component as described with reference to FIG. 3.

It should be noted that the methods described above describe possible implementations, and that the operations and the steps may be rearranged or otherwise modified and that other implementations are possible. Furthermore, portions from two or more of the methods may be combined.

An apparatus for method performed by a memory system is described. The apparatus may include a processor, memory in electronic communication with the processor, and instructions stored in the memory. The instructions may be executable by the processor to cause the apparatus to receive, from a host system, a set of commands as part of a boot procedure of the host system, the set of commands requesting data stored in a first set of locations of a memory array, retrieve, as part of the boot procedure, the data from the first set of locations of the memory array based on receiving the set of commands, determine an order that the data is retrieved from each location of the first set of locations as part of the boot procedure, and transfer the data from the first set of locations to a second set of locations based on the order that the data is retrieved from each location of the first set of locations.

Some examples may further include determining the second set of locations in the memory array for storing the data based on the order that the data may be retrieved, the second set of locations including a sequential set of physical addresses in the memory array, where transferring the data may be based on determining the second set of locations.

Some examples may further include transfer the data from a first set of physical addresses to a second set of physical addresses, where the first set of physical addresses correspond to a first pattern and the second set of physical addresses correspond to a second pattern different than the first pattern.

In some examples, the first pattern includes a random pattern and the second pattern includes a sequential pattern.

Some examples may further include operating in an idle mode subsequent to determining the order that the data may be retrieved from the each location of the first set of locations, where transferring the data from the first set of locations to the second set of locations may be based on operating in the idle mode.

Some examples may further include receiving, from the host system, a second set of commands of a second boot procedure, the second set of commands requesting the data, and retrieve, as part of the second boot procedure, the data from the second set of locations of the memory array based on receiving the second set of commands and transferring the data from the first set of locations to the second set of locations.

Some examples may further include access a word line including a sequential set of physical addresses storing the data, the second set of locations including the sequential set of physical addresses.

Some examples may further include updating a mapping table based on transferring the data from the first set of locations to the second set of locations, the mapping table including a correspondence between one or more logical addresses and one or more physical addresses of the memory device.

Some examples may further include updating a first mapping associated with the data to a second mapping associated with the data, the first mapping indicating a correspondence between one or more logical addresses of the data and a first set of physical addresses of the data, the second mapping indicating a correspondence between the one or more logical addresses of the data and a second set of physical addresses of the data.

Some examples may further include adjusting a granularity of an entry of the mapping table, the granularity indicating a quantity of physical addresses of the data that correspond to a logical address of the data.

Some examples may further include performing one or more media management operations for the memory array, and determine the second set of locations in the memory array for storing the data based on the one or more media management operations.

Some examples may further include identifying that the data may be associated with the boot procedure, where determining the second set of locations may be based on the data being associated with the boot procedure.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal; however, it will be understood by a person of ordinary skill in the art that the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to condition of moving from an open-circuit relationship between components in which signals are not presently capable of being communicated between the components over a conductive path to a closed-circuit relationship between components in which signals are capable of being communicated between components over the conductive path. When a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other when the switch is open. When a controller isolates two components, the controller affects a change that prevents signals from flowing between the components using a conductive path that previously permitted signals to flow.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as a n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” when a voltage greater than or equal to the transistor's threshold voltage is applied to the transistor gate. The transistor may be “off” or “deactivated” when a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details to providing an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus, comprising:
a memory array; and
a control component coupled with the memory array and configured to cause the apparatus to:
receive, from a host system, a set of commands as part of a boot procedure of the host system, the set of commands requesting data stored in a first set of locations of the memory array;
retrieve, as part of the boot procedure, the data from the first set of locations of the memory array based at least in part on receiving the set of commands;
determine an order that the data is retrieved from each location of the first set of locations as part of the boot procedure; and
transfer the data from the first set of locations to a second set of locations based at least in part on the order that the data is retrieved from each location of the first set of locations.

2. The apparatus of claim 1, wherein the control component is further configured to cause the apparatus to:
determine the second set of locations in the memory array for storing the data based at least in part on the order that the data is retrieved, the second set of locations comprising a sequential set of physical addresses in the memory array, wherein transferring the data is based at least in part on determining the second set of locations.

3. The apparatus of claim 1, wherein the control component is further configured to cause the apparatus to:
transfer the data from a first set of physical addresses to a second set of physical addresses, wherein the first set of physical addresses correspond to a first pattern and the second set of physical addresses correspond to a second pattern different than the first pattern.

4. The apparatus of claim 3, wherein the first pattern comprises a random pattern and the second pattern comprises a sequential pattern.

5. The apparatus of claim 1, wherein the control component is further configured to cause the apparatus to:
operate in an idle mode subsequent to determining the order that the data is retrieved from the each location of the first set of locations, wherein transferring the data from the first set of locations to the second set of locations is based at least in part on operating in the idle mode.

6. The apparatus of claim 1, wherein the control component is further configured to cause the apparatus to:
receive, from the host system, a second set of commands of a second boot procedure, the second set of commands requesting the data; and
retrieve, as part of the second boot procedure, the data from the second set of locations of the memory array based at least in part on receiving the second set of commands and transferring the data from the first set of locations to the second set of locations.

7. The apparatus of claim 6, the control component is further configured to cause the apparatus to:
access a word line comprising a sequential set of physical addresses storing the data, the second set of locations comprising the sequential set of physical addresses.

8. The apparatus of claim 1, wherein the control component is further configured to cause the apparatus to:
update a mapping table based at least in part on transferring the data from the first set of locations to the second set of locations, the mapping table comprising a correspondence between one or more logical addresses and one or more physical addresses of the memory array.

9. The apparatus of claim 8, the control component is further configured to cause the apparatus to:
update a first mapping associated with the data to a second mapping associated with the data, the first mapping indicating a first correspondence between the one or more logical addresses of the data and a first set of physical addresses of the data, the second mapping indicating a second correspondence between the one or more logical addresses of the data and a second set of physical addresses of the data.

10. The apparatus of claim 8, the control component is further configured to cause the apparatus to:
adjust a granularity of an entry of the mapping table, the granularity indicating a quantity of physical addresses of the data that correspond to a logical address of the data.

11. The apparatus of claim 1, wherein the control component is further configured to cause the apparatus to:
perform one or more media management operations for the memory array; and
determine the second set of locations in the memory array for storing the data based at least in part on the one or more media management operations.

12. The apparatus of claim 11, the control component is further configured to cause the apparatus to:
identify that the data is associated with the boot procedure, wherein determining the second set of locations is based at least in part on the data being associated with the boot procedure.

13. A non-transitory computer-readable medium storing code comprising instructions, which when executed by a processor of an electronic device, cause the electronic device to:
receive, from a host system, a set of commands as part of a boot procedure of the host system, the set of commands requesting data stored in a first set of locations of a memory array;
retrieve, as part of the boot procedure, the data from the first set of locations of the memory array based at least in part on receiving the set of commands;
determine an order that the data is retrieved from each location of the first set of locations as part of the boot procedure; and
transfer the data from the first set of locations to a second set of locations based at least in part on the order that the data is retrieved from each location of the first set of locations.

14. The non-transitory computer-readable medium of claim 13, wherein the instructions, when executed by the processor of the electronic device, further cause the electronic device to:
determine the second set of locations in the memory array for storing the data based at least in part on the order that the data is retrieved, the second set of locations comprising a sequential set of physical addresses in the memory array, wherein transferring the data is based at least in part on determining the second set of locations.

15. The non-transitory computer-readable medium of claim 13, wherein the instructions to transfer the data from the first set of locations to the second set of locations are executable by the processor of the electronic device to:
transfer the data from a first set of physical addresses to a second set of physical addresses, wherein the first set of physical addresses correspond to a first pattern and the second set of physical addresses correspond to a second pattern different than the first pattern.

16. The non-transitory computer-readable medium of claim 13, wherein the instructions, when executed by the processor of the electronic device, further cause the electronic device to:
operate in an idle mode subsequent to determining the order that the data is retrieved from the each location of the first set of locations, wherein transferring the data from the first set of locations to the second set of locations is based at least in part on operating in the idle mode.

17. The non-transitory computer-readable medium of claim 13, wherein the instructions, when executed by the processor of the electronic device, further cause the electronic device to:
update a mapping table based at least in part on transferring the data from the first set of locations to the second set of locations, the mapping table comprising a correspondence between one or more logical addresses and one or more physical addresses.

18. A method performed by a memory system, the method comprising:
receiving, from a host system, a set of commands as part of a boot procedure of the host system, the set of commands requesting data stored in a first set of locations of a memory array;
retrieving, as part of the boot procedure, the data from the first set of locations of the memory array based at least in part on receiving the set of commands;
determining an order that the data is retrieved from each location of the first set of locations as part of the boot procedure; and
transferring the data from the first set of locations to a second set of locations based at least in part on the order that the data is retrieved from each location of the first set of locations.

19. The method of claim 18, further comprising:
determining the second set of locations in the memory array for storing the data based at least in part on the order that the data is retrieved, the second set of locations comprising a sequential set of physical addresses in the memory array, wherein transferring the data is based at least in part on determining the second set of locations.

20. The method of claim 18, wherein transferring the data from the first set of locations to the second set of locations comprises:
transferring the data from a first set of physical addresses to a second set of physical addresses, wherein the first set of physical addresses correspond to a first pattern and the second set of physical addresses correspond to a second pattern different than the first pattern.

21. The method of claim 20, wherein the first pattern comprises a random pattern and the second pattern comprises a sequential pattern.

22. The method of claim 18, further comprising:
operating in an idle mode subsequent to determining the order that the data is retrieved from the each location of the first set of locations, wherein transferring the data from the first set of locations to the second set of locations is based at least in part on operating in the idle mode.

23. The method of claim 18, further comprising:
receiving, from the host system, a second set of commands of a second boot procedure, the second set of commands requesting the data; and
retrieving, as part of the second boot procedure, the data from the second set of locations of the memory array based at least in part on receiving the second set of commands and transferring the data from the first set of locations to the second set of locations.

24. The method of claim 23, wherein retrieving the data from the second set of locations comprises:
accessing a word line comprising a sequential set of physical addresses storing the data, the second set of locations comprising the sequential set of physical addresses.

25. The method of claim 18, further comprising:
updating a mapping table based at least in part on transferring the data from the first set of locations to the second set of locations, the mapping table comprising a correspondence between one or more logical addresses and one or more physical addresses of the memory system.
